(19) United States
(12) Patent Application Publication
(10) Pub. No.: US 2008/0226337 A1
(43) Pub. Date: Sep. 18, 2008

(54) DEVELOPING CARTRIDGE, IMAGE FORMING APPARATUS HAVING THE SAME, AND METHOD OF DETACHING DEVELOPING CARTRIDGE FROM IMAGE FORMING APPARATUS

(75) Inventors: Min-su HAN, Suwon-si (KR); Young-min Kim, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/838,413

(22) Filed: Aug. 14, 2007

(30) Foreign Application Priority Data
Mar. 15, 2007 (KR) 2007-25428

(51) Int. Cl. G03G 21/18

(52) U.S. Cl. 399/111

(57) ABSTRACT

A developing cartridge usable with an image forming apparatus includes a developing cartridge housing, and a handle disposed on one side of an upper surface of the developing cartridge housing, and having a gripping portion formed thereon to make an acute angle with the upper surface of the developing cartridge housing. The gripping portion is fixed to the developing cartridge housing by a pair of support portions, or is hinged with the developing cartridge housing.

### CROSS-REFERENCE TO RELATED APPLICATIONS

This application claims priority under 35 U.S.C. §119(a) from Korean Patent Application No. 2007-25428, filed on Mar. 15, 2007, in the Korean Intellectual Property Office, the entire disclosure of which is incorporated herein in its entirety by reference.

### BACKGROUND OF THE INVENTION

1. Field of the Invention

The present general inventive concept relates to an image forming apparatus, and more particularly to a developing cartridge, an image forming apparatus having the same, and a method of detaching a developing cartridge from the image forming apparatus.

2. Description of the Related Art

Generally, an image forming apparatus such as a laser printer and a copy machine is provided with a developing cartridge that forms a toner image that corresponds to print data.

The developing cartridge includes a photosensitive medium on which an electrostatic latent image that corresponds to print data is formed, a charge member to charge the photosensitive medium, and a developing member to develop the electrostatic latent image formed on the photosensitive medium into a toner image.

The photosensitive medium, the charge member, and the developing member, which constitute the developing cartridge, are printing consumables which should be replaced after a lapse of a predetermined time. Accordingly, the developing cartridge is formed as a single unit or module to facilitate the replacement of the developing cartridge.

FIG. 1 illustrates a developing cartridge that is detached from an image forming apparatus.

Referring to FIG. 1, a developing cartridge 10 is installed in a main body 20 of an image forming apparatus 1, and has a handle 12 installed on a front surface of a developing cartridge housing 11.

The handle 12 is installed in a position in which a user can easily hold the developing cartridge 10 when the user separates the developing cartridge 10 from the main body 20 of the image forming apparatus 1, i.e., when the user detaches the developing cartridge 10 from the image forming apparatus 1. Accordingly, generally the handle 12 is installed in a direction in which the user is positioned when the user detaches the developing cartridge 10 from the main body 20 of the image forming apparatus 1. That is, in the conventional developing cartridge 10, the handle 12 is installed in the developing cartridge housing 11 in a direction in which the developing cartridge 10 is detached from the image forming apparatus 1.

Accordingly, if the user intends to detach the developing cartridge 10 from the main body 20 of the image forming apparatus 1, the user opens a cover 21 of the image forming apparatus 1, holds the handle 12 of the developing cartridge 10, and then pulls the handle 12 to the front of the image forming apparatus 1 as illustrated in FIG. 1.

However, the conventional developing cartridge 10 has a drawback that the handle 12 is formed in a direction in which the developing cartridge 10 is detached, and thus if components of the image forming apparatus 1 are installed in the direction in which the developing cartridge 10 is detached, it becomes difficult to detach the developing cartridge 10 from the main body 20 of the image forming apparatus 1. Particularly, where the image forming apparatus in which a fuser unit (not illustrated) is installed in the direction in which the developing cartridge 10 is detached, a user who detaches the developing cartridge may be injured due to a high-temperature heat generated from the fuser unit.

### SUMMARY OF THE INVENTION

Exemplary embodiments of the present general inventive concept have been developed in order to substantially solve the above and other problems associated with the conventional arrangement and provide the objectives listed below. The present general inventive concept provides a developing cartridge, an image forming apparatus having the same, and a method of detaching a developing cartridge from the image forming apparatus, whereby the developing cartridge can be detached without being interfered with by components of the image forming apparatus disposed in a direction in which the developing cartridge is detached.

Additional aspects and utilities of the present general inventive concept will be set forth in part in the description which follows and, in part, will be obvious from the description, or may be learned by practice of the general inventive concept.

The foregoing and other aspects and utilities may be achieved by providing a developing cartridge for an image forming apparatus a developing cartridge housing; and a handle disposed on one side of an upper surface of the developing cartridge housing, and having a gripping portion formed thereon to make an acute angle with the upper surface of the developing cartridge housing.

The gripping portion may be fixed to the developing cartridge housing by at least one support portion, or may be hinged with the developing cartridge housing.

Rotary projections may be formed on both side surfaces of the developing cartridge housing, and when a user holds the handle, the developing cartridge housing may be rotated around the rotary projections.

The rotary projections may be disposed on a same axis as a photosensitive medium disposed in the developing cartridge housing.

The foregoing and/or other aspects and utilities of the present general inventive concept may also be achieved by providing an image forming apparatus, which includes a lower frame, an upper frame hinged with an upper side of the lower frame, and a developing cartridge detachably disposed in the lower frame, and including a developing cartridge housing and a handle disposed on one side of an upper surface of the developing cartridge housing and having a gripping portion formed thereon to make an acute angle with the upper surface of the developing cartridge housing.

Rotary projections may be formed on both side surfaces of the developing cartridge housing, and rotary projection receiving portions to support the developing cartridge to be rotated around the rotary projections may be disposed in the lower frame.

When a user holds the gripping portion of the handle, the developing cartridge may be rotated around the rotary projections.

When the upper frame is opened, the developing cartridge may be rotated around the rotary projections, be lifted up from the rotary projection receiving portions, and then be detached from the lower frame through a space between the upper frame and the lower frame.

A fuser unit may be disposed in the lower frame and in front of the developing cartridge in a direction in which the developing cartridge is detached.

The foregoing and/or other aspects and utilities of the general inventive concept may also be achieved by providing a method of detaching a developing cartridge from an image forming apparatus, which includes opening an upper frame against a lower frame by rotating the upper frame by a predetermined angle around a hinge shaft, holding a handle so that the handle makes an acute angle with an upper surface of a developing cartridge housing of the developing cartridge disposed in the lower frame through a space formed between the upper frame and the lower frame, holding the handle and lifting the developing cartridge upward and holding the handle and pulling out the developing cartridge in the space between the upper frame and the lower frame.

The developing cartridge may be lifted to a height where the developing cartridge is not interfered with by a fuser unit disposed in the lower frame.

When a user holds the handle, the developing cartridge may be rotated around rotary projections formed in the developing cartridge housing.

The foregoing and/or other aspects and utilities of the general inventive concept may also be achieved by providing a handle for a developing cartridge detachably disposed in an image forming apparatus, wherein the developing cartridge includes a developing cartridge housing, and rotary projections formed on both side surfaces of the developing cartridge housing, wherein the handle is fixed in a body to one side of an upper surface of the developing cartridge housing, a gripping portion of the handle is formed on the handle to make an acute angle with the upper surface of the developing cartridge housing and a user can hold the handle of the developing cartridge mounted on the image forming apparatus.

The foregoing and/or other aspects and utilities of the general inventive concept may also be achieved by providing a handle for a developing cartridge detachably disposed in an image forming apparatus, wherein the developing cartridge includes a developing cartridge housing, and rotary projections formed on both side surfaces of the developing cartridge housing, wherein the handle is hinged with one side of an upper surface of the developing cartridge housing, a gripping portion of the handle is formed on the handle to make an acute angle with the upper surface of the developing cartridge housing, and when a user holds the handle of the developing cartridge mounted on the image forming apparatus, the developing cartridge is rotated around the rotary projections.

The handle may be disposed so that a lower surface of the gripping portion faces a rear end of the developing cartridge housing.

The foregoing and/or other aspects and utilities of the general inventive concept may also be achieved by providing a developing cartridge housing for a developing cartridge detachably disposed in an image forming apparatus, wherein the developing cartridge includes a handle disposed on one side of an upper surface of the developing cartridge housing, and rotary projections formed on both side surfaces of the developing cartridge housing, wherein a gripping portion of the handle is formed on the handle to make an acute angle with the upper surface of the developing cartridge housing, and when a user holds the handle of the developing cartridge mounted on the image forming apparatus, the developing cartridge is rotated around the rotary projections.

The foregoing and/or other aspects and utilities of the general inventive concept may also be achieved by providing a developing cartridge usable with an image forming apparatus, the developing cartridge including a housing having an upper surface and a lower surface to form a space to accommodate a developing component, and a handle disposed on the upper surface of the housing, the handle including a gripping portion and a support portion to connect the gripping portion to the upper surface of the housing, wherein the gripping portion forms an acute angle with the upper surface of the housing.

The foregoing and/or other aspects and utilities of the general inventive concept may also be achieved by providing an image forming apparatus, including a lower frame, an upper frame rotatably connected to the lower frame and a developing cartridge disposed in one of the lower frame or the upper frame and including a housing having an upper surface and a lower surface and a handle disposed on the upper surface of the housing, the handle including a gripping portion forming an acute angle with the upper surface of the housing, and a support portion to connect the gripping portion to the upper surface of the housing.

The foregoing and/or other aspects and utilities of the general inventive concept may also be achieved by providing a developing cartridge usable with an image forming apparatus, the developing cartridge including a housing detachable connected to the image forming apparatus and having an upper surface and a lower surface, and a handle rotatably connected to the housing and having a closed state and an open state so that in a closed state the handle is substantially parallel to the upper surface of the housing and in an open state the handle forms an acute angle with the upper surface of the housing.

The foregoing and/or other aspects and utilities of the general inventive concept may also be achieved by providing a method of detaching a developing cartridge from an image forming apparatus, the method including rotating a handle of the developing cartridge to an open state in which an upper surface of the developing cartridge forms an acute angle with the handle, and moving the developing cartridge from the image forming apparatus.

The foregoing and/or other aspects and utilities of the general inventive concept may also be achieved by providing a developing cartridge usable with an image forming apparatus, the developing cartridge comprising a housing, a handle formed on the housing, and having a grip portion and a support portion extended from a surface of the housing at an acute angle with respect to the surface to fixedly support the grip portion.

The foregoing and/or other aspects and utilities of the general inventive concept may also be achieved by providing an image forming apparatus comprising a frame, and a developing cartridge disposed in the frame, and having a housing and a handle formed on the housing, and having a grip portion and a support portion extended from a surface of the housing at an acute angle with respect to the surface to support the grip portion with respect to the surface.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a side view illustrating a conventional developing cartridge that is detached from an image forming apparatus;

FIG. 2 is a perspective view illustrating a developing cartridge according to an exemplary embodiment of the present general inventive concept;

FIGS. 3A and 3B are side views illustrating a developing cartridge according to another exemplary embodiment of the present general inventive concept;

FIG. 4 is a sectional view schematically illustrating an image forming apparatus provided with a developing cartridge according to an exemplary embodiment of the present general inventive concept;

FIG. 5 is a sectional view illustrating an upper frame of the image forming apparatus of FIG. 4 in an open state; and

FIGS. 6A to 6C are conceptual views explaining the movement of a developing cartridge when it is detached from the image forming apparatus of FIG. 5.

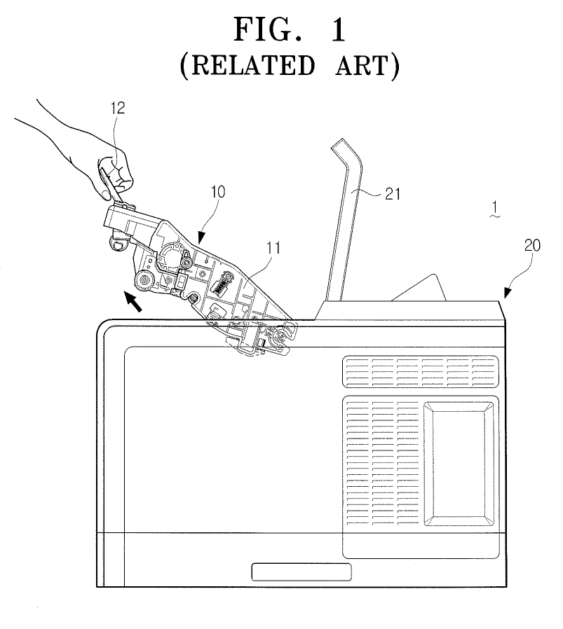

Throughout the drawings, like reference numerals will be understood to refer to like parts, components and structures.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

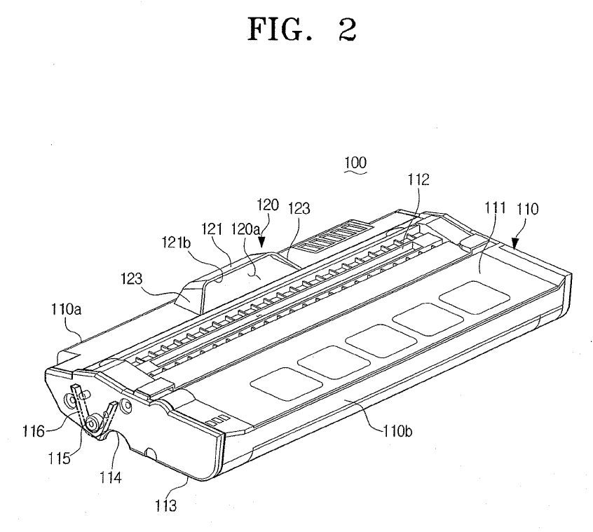

FIG. 2 is a perspective view illustrating a developing cartridge 100 according to an exemplary embodiment of the present general inventive concept.

Referring to FIG. 2, the developing cartridge 100 according to an exemplary embodiment of the present general inventive concept includes a developing cartridge housing 110 and a handle 120.

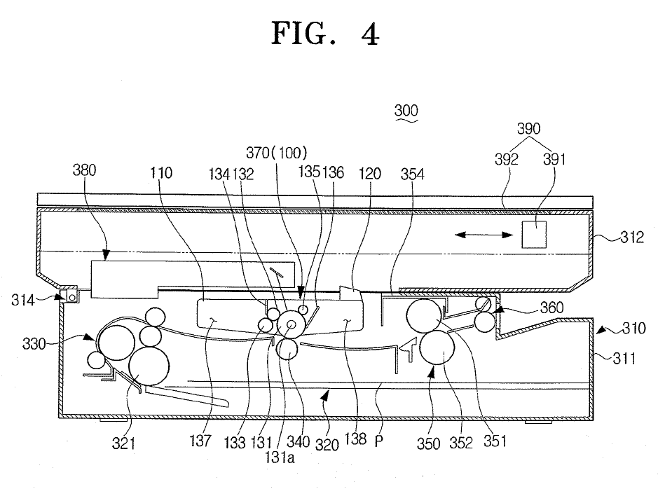

The developing cartridge housing 110 forms an external appearance of the developing cartridge 100. The developing cartridge housing 110 includes a laser beam hole 112 formed on an upper surface 111, to which laser beams emitted from an exposing unit 380 (FIG. 4) enter, and a photosensitive medium hole 114 formed on a lower surface 113, through which a portion of a photosensitive medium 131 (FIG. 4) is exposed.

On both side surfaces of the developing cartridge housing 110, a pair of rotary projections 115 is formed. The pair of rotary projections 115 are supported by a pair of rotary projection receiving portion 116 formed on a main body 310 of an image forming apparatus 300 (FIG. 4). Accordingly, when a user holds the handle 120, the developing cartridge 100 is rotated by a predetermined angle around the pair of rotary projections 115. The pair of rotary projections 115, for example, are installed on the same axis as an axis 131a (FIG. 4) of a photosensitive medium 131 installed in the developing cartridge housing 110.

In the developing cartridge housing 110, as illustrated in FIG. 4, one or more developing components having the photosensitive medium 131, a developing member 132, a toner feed member 133, a toner restriction member 134, a charge member 135, and/or a waste toner cleaner 136 are installed.

The photosensitive medium 131 is formed in a form of a cylinder, and an electrostatic latent image is formed on the photosensitive medium 131 by the laser beams emitted from the exposing unit 380. The photosensitive medium 131 is rotatably installed in the developing cartridge housing 110, and a portion thereof is exposed to an outside through the photosensitive medium hole 114 (FIG. 2) formed on the developing cartridge housing 110.

The developing member 132 develops the electrostatic latent image formed on the photosensitive medium 131 into a toner image by feeding toner. In the exemplary embodiment of the present general inventive concept, the developing member 132 is formed in the form of a roller, and is rotatably installed on one side of the photosensitive medium 131 in the developing cartridge housing 110.

The toner feed member 133 feeds the toner to the developing member 132. In the exemplary embodiment of the present general inventive concept, the toner feed member 133 is formed in a form of a roller, and is rotatably installed on one side of the developing member 132 in the developing cartridge housing 110.

The toner restriction member 134 is installed in the developing cartridge housing 110 to be in contact with the developing member 132, and thins the toner conveyed to the developing member 132. Accordingly, the toner existing on the developing member 132 is charged with electricity through friction with the toner restriction member 134.

The charge member 135 charges the photosensitive medium 131 with a predetermined voltage. In the exemplary embodiment of the present general inventive concept, the charge member 135 is in a form of a roller, and is rotatably installed in the developing cartridge housing 110.

The waste toner cleaner 136 removes the waste toner remaining on the photosensitive medium 131 after the toner image is transported to a print medium P, and is installed in the developing cartridge housing 110 to be in contact with the photosensitive medium 131.

In the developing cartridge housing 110, a toner storing place 137 to store a predetermined amount of toner and a waste toner storing place 138 to store the waste toner removed from the photosensitive medium 131.

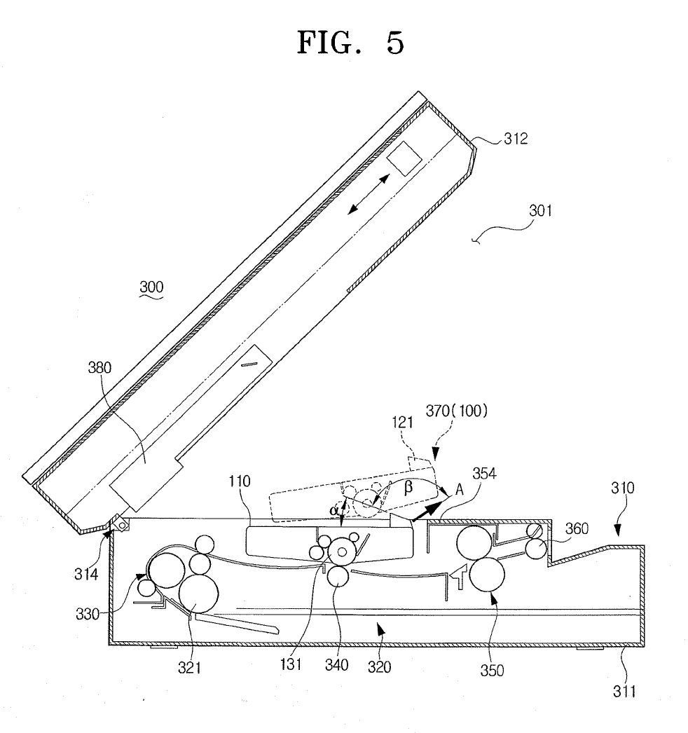

The handle 120 is held by a user when the user detaches the developing cartridge 100 from the main body 310 of the image forming apparatus 300, and is installed on one side of the upper surface 111 of the developing cartridge housing 110. Accordingly, as illustrated in FIG. 2, the handle 120 is installed at an edge of the upper surface 111 of the developing cartridge housing 110 in a direction (as indicated by an arrow A in FIG. 5) in which the developing cartridge 100 is detached from the main body 310 of the image forming apparatus 300. If it is assumed that one end of the developing cartridge housing 110 in a direction (as indicated by an arrow A) in which the developing cartridge 100 is detached is called a front end 110a of the developing cartridge housing 110, and the opposite end thereof is called a rear end 110b of the developing cartridge housing 110, the handle 120 is formed so that its inlet 120a faces the rear end 110b of the developing cartridge housing 110.

The handle 120 includes a gripping portion 121 that the user holds and a pair of support portions 123 to connect the gripping portion 121 to the developing cartridge housing 110.

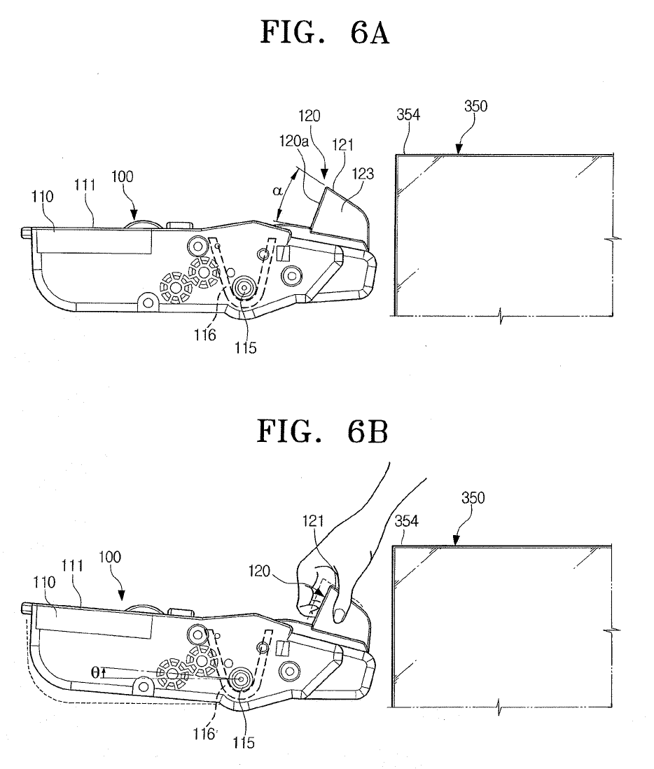

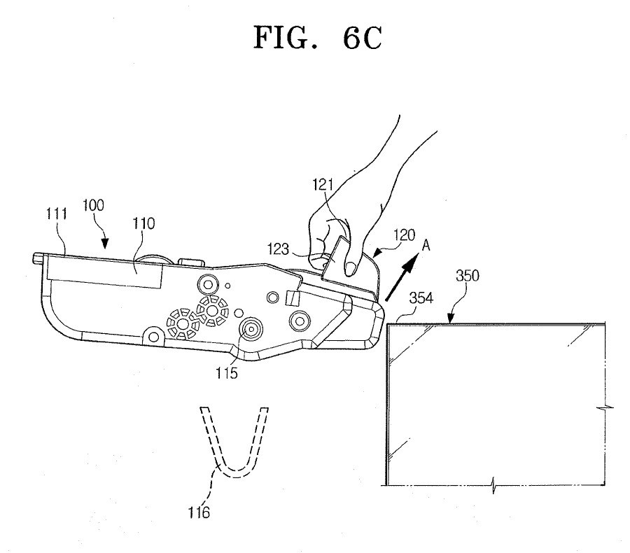

The gripping portion 121 is formed to make an acute angle α (FIG. 6A) with the upper surface 111 of the developing cartridge housing 110. That is, a lower surface 121b of the gripping portion 110 faces the rear end 110b of the developing cartridge housing 110. Accordingly, the gripping portion 121 of the handle 120 is formed to make an obtuse angle β with the direction (as indicated by an arrow A) in which the developing cartridge 100 is detached from the main body 310 of the image forming apparatus 300 as illustrated in FIG. 5. Accordingly, the user puts his/her hand into the inlet 120a of the handle 120 from above approximately the center portion of the developing cartridge housing 110 and holds the gripping portion 121. Since the lower surface 121b of the gripping portion 121 is formed to face the rear end 110b of the developing cartridge housing 110, the user lifts up the developing cartridge 100 from the main body 310 of the image forming apparatus 300, and then pulls the developing cartridge 100 out of the main body 310 of the image forming apparatus 300.

In addition, as the gripping portion 121 is formed at an acute angle α with the upper surface 111 of the developing cartridge housing 110, an area of the gripping portion 121 contacting the palm and the lower portions of the fingers can be greatly increased. As the wider area of the gripping portion 121 of the handle 120 is in contact with the palm and the lower portions of the fingers, the user can stably hold the developing cartridge 100, and the weight of the developing cartridge 100 can be supported by force.

The pair of support portions 123 is coupled to both sides of the gripping portion 121 so as to fix the gripping portion 121 to the developing cartridge housing 110.

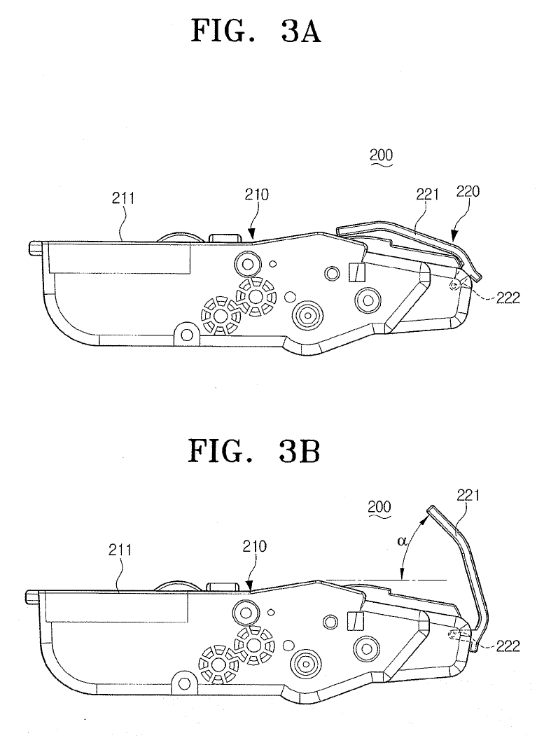

FIGS. 3A and 3B are side views illustrating a developing cartridge 200 according to another exemplary embodiment of the present general inventive concept. FIG. 3A illustrates the state in which a handle 220 is closed, and FIG. 3B illustrates a state in which the handle 220 is opened to detach the developing cartridge 200 from the apparatus.

Referring to FIGS. 3A and 3B, the developing cartridge 200 according to another exemplary embodiment of the present general inventive concept includes a developing cartridge housing 210 and the handle 220.

The developing cartridge housing 210 houses the developing cartridge 200, and since construction thereof is similar to the developing cartridge housing 110, it will not be described in detail herein.

The handle 220 is installed on a portion of an upper surface 211 of the developing cartridge housing 210 and a user grips the handle 220 to detach the developing cartridge 200 from the main body 310 of the image forming apparatus 300 (FIG. 4). Accordingly, the handle 220 is installed on an edge of the upper surface 211 of the developing cartridge housing 210 in a direction in which the developing cartridge 200 is detached from the main body 310 of the image forming apparatus 300, as illustrated in FIGS. 3A and 3B.

The handle 220 includes a gripping portion 221 for the grip of a user and a hinge portion 222 hingedly engaging the gripping portion 221 with the housing 210.

The hinge portion 222 connects the gripping portion 221 with the developing cartridge housing 210 so that the gripping portion 221 rotates relative to the housing 210 at a specific angle. Accordingly, the hinge portion 222 is adapted so that the gripping portion 221 rotates to the upper surface 211 of the developing cartridge housing 210 at an angle of up to 90°. In this exemplary embodiment, as illustrated in FIG. 3B, the hinge portion 222 restricts so that the gripping portion 221 rotates to the upper surface 211 of the developing cartridge housing 210 at an acute angle α when the gripping portion 221 is opened. Consequently, if the user pulls the gripping portion 221 to detach the developing cartridge 200 from the developing cartridge housing 210, the gripping portion 221 is at an acute angle α to the upper surface 211 of the developing cartridge housing 210.

The gripping portion 221 can rotate around the hinge portion 222 at a certain angle. Where the developing cartridge 200 is mounted on the main body 310 of the image forming apparatus 300, the gripping portion 221 comes in contact with the upper surface 211 of the developing cartridge housing 210, as illustrated in FIG. 3A. Where the developing cartridge 200 is detached from the developing cartridge housing, as illustrated in FIG. 3B, the gripping portion 221 is opened. Accordingly, the gripping portion 221 is at an acute angle α to the upper surface 211 of the developing cartridge housing 210. In this exemplary embodiment, the gripping portion 221 of the developing cartridge 200 is similar to the gripping portion 121 of the handle 120 of the developing cartridge 100 according to the above exemplary embodiment, except that the gripping portion 221 is connected to the developing cartridge housing 210 by the hinge portion 222. Therefore, the gripping portion 221 will not be described in detail herein.

FIG. 4 is a cross-sectional view schematically illustrating the image forming apparatus 300 including a developing cartridge 370 according to an exemplary embodiment of the present general inventive concept.

Referring to FIG. 4, the image forming apparatus 300 having the developing cartridge 370 according to an exemplary embodiment of the present general inventive concept includes a main body 310, a print medium feed unit 320, a transport roller unit 330, an exposing unit 380, a developing cartridge 370, a fuser unit 350, and a delivery unit 360.

The main body 310 includes a lower frame 311 and an upper frame 312 to form an appearance of the image forming apparatus 300.

The print medium feed unit 320, the transport roller unit 330, the developing cartridge 370, the transport roller 340, the fuser unit 350, and the delivery unit 360 are installed in the lower frame 311.

The print medium feed unit 320 is loaded with a plurality of sheets of print medium P, in which the loaded print medium P is picked up one by one by a pickup roller 321 installed on a front end of the print medium feed unit 320, and then is fed to the transport roller unit 330.

The transport roller unit 330 includes at least one pair of transport rollers to transport the picked-up print medium P from the print medium feed unit 320 between the transport roller 340 and the photosensitive medium 131 of the developing cartridge 370.

The developing cartridge 370 develops the electrostatic latent image formed by the laser beam generated from the exposing unit 380 into a toner image. Construction of the developing cartridge 370 is similar to the developing cartridge 100 according to the above exemplary embodiment of the present general inventive concept, and thus will not be described in detail. Herein, the developing cartridge 370 will be described by referring to reference numerals of the developing cartridge 100 of the above exemplary embodiment.

The lower frame 311 is provided at positions adjacent to both ends of the transport roller 340 with a rotary projection receiving portion 116 (FIG. 2) to support the rotary projection 115 (FIG. 2) of the developing cartridge 100. If the rotary projection 115 of the developing cartridge 100 is positioned in the rotary projection receiving portion 116, the photosensitive medium 131 of the developing cartridge 100 comes in contact with the transport roller 340. Accordingly, the rotary projection receiving portion 116 of the lower frame 311 is adapted so that the developing cartridge 100 can rotate around the rotary projection 115 at a certain angle. Consequently, the developing cartridge 100 can rotate to the lower frame 311.

In order to restrict the rotation angle of the developing cartridge 100, stoppers (not illustrated) to restrict the rotation angle of the developing cartridge 100 may be installed on the lower frame 311 and the upper frame 312. The stoppers are installed at proper positions of the upper frame 312 and the lower frame 311 so that the stoppers come in contact with the developing cartridge housing 110 to restrict the rotation angle of the developing cartridge 100.

If the developing cartridge is mounted on the lower frame 311, the handle 120 is positioned at a direction in which the developing cartridge is released from the main body 310 of the image forming apparatus 300. Accordingly, the handle 120 of the developing cartridge 100 is positioned close to the fuser unit 350.

The transport roller 340 is installed on the lower frame 311 such that it comes in contact with the photosensitive medium 131 and rotates. The toner image formed on the photosensitive medium 131 is transported to the print medium P transported from the print medium feed unit 320 by the transport roller 340.

The fuser unit 350 is installed on the lower frame 311 in front of the developing cartridge 100. That is, in this exemplary embodiment, the fuser unit 350 is installed in front of the developing cartridge 100 in a direction (indicated by arrow A), in which the developing cartridge 100 is detached from the lower frame 311, as illustrated in FIG. 5. The fuser unit 350 includes a press roller 352 and a heating roller 351, and applies heat and high pressure to the print medium P passing through the press roller 352 and the heating roller 351 to fix the transported toner image onto the print medium P. The fuser unit 350 is provided on the upper portion thereof with a fuser cover 354 to prevent a user's hand from coming in contact with the fuser unit 350 when the upper frame 312 is opened. During print, the fuser cover 354 is heated by the heating roller 351 of the fuser unit 350. Consequently, the user may be damaged if his or her hand comes in contact with the fuser cover 354.

The delivery unit 360 discharges the print medium P, in which the fixing is completed by the fuser unit 350, from the image forming apparatus 300.

The upper frame 312 is installed to cover the lower frame 311. In this exemplary embodiment, the upper frame 312 is hingedly coupled to the lower frame 311, and includes a scanning unit 390 and the exposing unit 380.

The upper frame 312 is provided on one end thereof with a main body hinge portion 314 to hingedly couple the upper frame 312 with the lower frame 311. The hinge portion 314 includes a hinge shaft and a hinge hole. Where the hinge shaft is formed in the upper frame 312, the hinge hole is formed on the lower frame 311. Consequently, the upper frame 312 can rotate around the hinge portion 314 at a certain angle to the lower frame 311. In this exemplary embodiment, the upper frame 312 is adapted to rotate around the hinge portion 314 at about 40 degrees to about 80 degrees to the lower frame 311.

The scanning unit 390 scans a document, and includes a scanning module 391 linearly moved to scan the document and a copyholder 392 on which the document is laid. The scanning module 391 and the copyholder 392 are substantially similar to the flat scanner used in a common combination machine. Consequently, the scanning unit 390 will not be described in detail herein.

The exposing unit 380 forms an electrostatic latent image on the photosensitive medium 131 of the developing cartridge 100 by irradiating laser beams corresponding to the received print data. The exposing unit 380 is mounted to the upper frame 312 at the upper portion of the developing cartridge 100. The exposing unit 380 is substantially similar to an exposing unit used in a general image forming apparatus, the detailed description thereof will be omitted.

The operation of the image forming apparatus 300 will now be described with reference to FIG. 4.

If a print command is received, the image forming apparatus 300 applies a voltage to the charge member 135 of the developing cartridge 100 to charge the surface of the photosensitive medium 131 with a predetermined voltage, and rotates the photosensitive medium 131.

Nearly simultaneously, the exposing unit 380 is driven to irradiate the laser beam corresponding to the received print data. The laser beam irradiated from the exposing unit 380 is incident onto the photosensitive medium 131 through a laser beam hole 112 (FIG. 2) formed on the upper surface 111 of the developing cartridge housing 110 of the developing cartridge 100 to form the electrostatic latent image corresponding to the print data onto the photosensitive medium 131 charged by the charge member 135.

If the photosensitive medium 131 rotates continuously, the electrostatic latent image formed on the photosensitive medium 131 is shifted to a position facing the developing cartridge member 132. The electrostatic latent image is thus developed into a toner image by the toner transported by the developing cartridge member 132. The toner stored in the toner storing space 137 of the developing cartridge housing 110 is supplied to the developing cartridge member 132 by the toner feed member 133, and is thinned by the toner restriction member 134 before it is supplied to the photosensitive medium 131.

Meanwhile, if the print command is received, the print medium feed unit 320 picks up one sheet of the print medium P, and transports it to the transport roller unit 330. The picked-up print medium P enters a gap between the photosensitive medium 131 of the developing cartridge 100 and the transport roller 340 installed on the lower frame 311 by the transport roller unit 330.

If the print medium P enters between the photosensitive medium 131 of the developing cartridge 100 and the transport roller 340, the toner image formed on the rotating photosensitive medium 131 is transported onto the print medium P.

When the photosensitive medium 131 rotates continuously, the wasted toner cleaner 136 eliminates the toner remaining on the surface of the photosensitive medium 131 after the toner image is transported onto the print medium P. The wasted toner eliminated from the photosensitive medium 131 is stored in the wasted toner space 138 of the developing cartridge housing 110.

When the photosensitive medium 131 rotates continuously, the charge member 135 again charges the surface of the photosensitive medium 131 with a predetermined voltage.

The photosensitive medium 131 charged with a predetermined voltage is repeatedly subjected to the above process, so that the toner image is continuously transported onto the print medium P.

The print medium P transported with the toner image from the photosensitive medium 131 of the developing cartridge 100 is moved to the fuser unit 350. The transported toner image is fused on the print medium P while the print medium P passes between the press roller 132 of the fuser unit 350 and the heating roller 131.

The print medium P fused with the toner image is outwardly discharged from the image forming apparatus 300 through the delivery unit 360.

The method of detaching the developing cartridge 100 of the present general inventive concept from the image forming apparatus 300 will now be described in detail with reference to FIGS. 5 and 6A to 6C.

The developing cartridge 100 is replaced, for example, by the user opening the upper frame 312 of the main body 310 of the image forming apparatus 300 from the lower frame 311. That is, the upper frame 312 is rotated around the main body hinge portion 314 at a predetermined angle, as illustrated in FIG. 5, to form the space 301 between the lower frame 311 and the upper frame 312.

The user stretches out his or her hand into the space 301 formed between the upper frame 312 and the lower frame 311, and then holds the handle 120 of the developing cartridge 100 mounted in the rear of the fuser unit 350 of the lower frame 311, as illustrated in FIG. 6A. Accordingly, the user inserts his or her fingers into the inlet 120a of the handle 120, and then holds the handle 120 of the developing cartridge 100 so that the palm and lower portions of his or her fingers come in contact with the gripping portion 121.

If the user holds the handle 120 of the developing cartridge 100, the developing cartridge 100 rotates around the rotary projection 115 at a predetermined angle θ, as illustrated in FIG. 6B. Since the gripping portion 121 of the handle 120 is at an acute angle α to the upper surface 111 of the developing cartridge housing 110, the user's hand does not come in contact with the fuser cover 354 covering the fuser unit 350 when the user holds the handle 120.

The user lifts up the developing cartridge 100, as illustrated in FIG. 6C, with the user gripping the handle 120. The rotary projection 115 of the developing cartridge 100 is extracted from the rotary projection receiving portion 116 of the lower frame 311. When the developing cartridge 100 is extracted from the space 301 between the upper frame 312 and the lower frame 311, the user lifts up the developing cartridge 100 by a height which is free from interference of the fuser unit 350, and then rotates the developing cartridge 100 at a proper angle.

Next, the user detaches the developing cartridge 100 from the lower frame 311 through the space 301 between the upper frame 312 and the lower frame 311, while gripping the handle 120.

Accordingly, the developing cartridge 100 includes the handle 120 having the gripping portion 121 which is at an acute angle α to the developing cartridge housing 110. The user holds the gripping portion 121 of the handle 120, lifts up the developing cartridge 100 installed in the rear of the fuser unit 350, and then easily extracts the developing cartridge from the narrow space 301 between the upper frame 312 and the lower frame 311.

Also, since the gripping portion 121 of the handle 120 has a wide contact area, the user can hold the developing cartridge 100 stably, and supports the developing cartridge 100 with sufficient force.

Accordingly, with the developing cartridge 100 according to an exemplary embodiment of the present general inventive concept, the user can conveniently control a posture of the developing cartridge 100 in the space 301 formed between the upper frame 312 and the lower frame 311, that is the detaching passage of the developing cartridge 100 while the user detaches the developing cartridge 100 from the lower frame 311 of the main body 310, so that the developing cartridge 100 does not interfere with the upper frame 312 and the lower frame 311. Accordingly, the posture control of the developing cartridge 100 by the user such that the user holds the gripping portion 121 of the handle 120, and then tilts or rotates the developing cartridge 100 by a certain angle against the lower frame 311.

As described above, according to the developing cartridge, the image forming apparatus having the same, and the method of detaching the developing cartridge from the image forming apparatus, the user can easily change the posture of the developing cartridge when detaching the developing cartridge from the image forming apparatus, and thus the developing cartridge can be easily detached from the main body of the image forming apparatus. Particularly, even where the image forming apparatus in which the fuser unit is installed in front of the developing cartridge in a direction in which the developing cartridge is detached from the image forming apparatus, the developing cartridge can be detached without being interfered by components of the image forming apparatus installed in a direction in which the developing cartridge is detached.

In addition, according to the developing cartridge of the present general inventive concept, since the gripping portion of the handle makes an acute angle with the upper surface of the developing cartridge housing, the user can easily rotate the developing cartridge with holding the handle.

Also, according to the developing cartridge of the present general inventive concept, since the gripping portion of the handle makes an acute angle with the upper surface of the developing cartridge housing, the area of the gripping portion can be greatly extended. Accordingly, the user can hold the handle of the developing cartridge with the sufficient force.

Although various embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A developing cartridge usable with an image forming apparatus, comprising:
a developing cartridge housing; and
a handle disposed on one side of an upper surface of the developing cartridge housing, and having a gripping portion formed thereon to make an acute angle with the upper surface of the developing cartridge housing.

2. The developing cartridge of claim 1, wherein the gripping portion is fixed to the developing cartridge housing by at least one support part.

3. The developing cartridge of claim 1, wherein the gripping portion is hinged with the developing cartridge housing.

4. The developing cartridge of claim 1, wherein rotary projections are formed on both side surfaces of the developing cartridge housing, and when a user holds the handle, the developing cartridge housing is rotated around the rotary projections.

5. The developing cartridge of claim 4, wherein the rotary projections are disposed on a same axis as a photosensitive medium disposed in the developing cartridge housing.

6. An image forming apparatus comprising:
a lower frame;
an upper frame hinged with an upper side of the lower frame; and
a developing cartridge detachably disposed in the lower frame, and including a developing cartridge housing and a handle disposed on one side of an upper surface of the developing cartridge housing and having a gripping portion formed thereon to make an acute angle with the upper surface of the developing cartridge housing.

7. The image forming apparatus of claim 6, wherein the gripping portion is fixed to the developing cartridge housing by a pair of support portions.

8. The image forming apparatus of claim 6, wherein the gripping portion is hinged with the developing cartridge housing.

9. The image forming apparatus of claim 6, wherein rotary projections are formed on both side surfaces of the developing cartridge housing, and rotary projection receiving portions to support the developing cartridge to be rotated around the rotary projections are disposed in the lower frame.

10. The image forming apparatus of claim 9, wherein the rotary projections are disposed on a same axis as a photosensitive medium disposed in the developing cartridge housing.

11. The image forming apparatus of claim 9, wherein when a user holds the gripping portion of the handle, the developing cartridge is rotated around the rotary projections.

12. The image forming apparatus of claim 11, wherein when the upper frame is opened, the developing cartridge is rotated around the rotary projections, is lifted up from the rotary projection receiving portions, and then is detached from the lower frame through a space between the upper frame and the lower frame.

13. The image forming apparatus of claim 6, wherein a fuser unit is disposed in the lower frame and in front of the developing cartridge in a direction in which the developing cartridge is detached.

14. A method of detaching a developing cartridge from an image forming apparatus, comprising:
opening an upper frame against a lower frame by rotating the upper frame by a predetermined angle around a hinge shaft;
holding a handle so that the handle makes an acute angle with an upper surface of a developing cartridge housing of the developing cartridge disposed in the lower frame through a space formed between the upper frame and the lower frame;
holding the handle and lifting the developing cartridge upward; and
holding the handle and pulling out the developing cartridge in the space between the upper frame and the lower frame.

15. The method of claim 14, wherein the developing cartridge is lifted to a height where the developing cartridge is not interfered with by a fuser unit disposed in the lower frame.

16. The method of claim 14, wherein when a user holds the handle, the developing cartridge is rotated around rotary projections formed in the developing cartridge housing.

17. A handle usable with a developing cartridge detachably disposed in an image forming apparatus, wherein the developing cartridge comprises:
a developing cartridge housing; and
rotary projections formed on both side surfaces of the developing cartridge housing;
wherein the handle is fixed in a body to one side of an upper surface of the developing cartridge housing, a gripping portion of the handle is formed on the handle to make an acute angle with the upper surface of the developing cartridge housing; and a user can hold the handle of the developing cartridge mounted on the image forming apparatus.

18. The handle of claim 17, wherein the handle is disposed so that a lower surface of the gripping portion faces a rear end of the developing cartridge housing.

19. A handle usable with a developing cartridge detachably disposed in an image forming apparatus, wherein the developing cartridge comprises:
a developing cartridge housing; and
rotary projections formed on both side surfaces of the developing cartridge housing;
wherein the handle is hinged with one side of an upper surface of the developing cartridge housing, a gripping portion of the handle is formed on the handle to make an acute angle with the upper surface of the developing cartridge housing, and when a user holds the handle of the developing cartridge mounted on the image forming apparatus, the developing cartridge is rotated around the rotary projections.

20. The handle of claim 19, wherein the handle is disposed so that a lower surface of the gripping portion faces a rear end of the developing cartridge housing.

21. A developing cartridge housing usable with a developing cartridge detachably disposed in an image forming apparatus, wherein the developing cartridge comprises:
a handle disposed on one side of an upper surface of the developing cartridge housing; and
rotary projections formed on both side surfaces of the developing cartridge housing;
wherein a gripping portion of the handle is formed on the handle to make an acute angle with the upper surface of the developing cartridge housing, and when a user holds the handle of the developing cartridge mounted on the image forming apparatus, the developing cartridge is rotated around the rotary projections.

22. The developing cartridge of claim 21, wherein the gripping portion is fixed to the developing cartridge housing by a pair of support portions.

23. The developing cartridge of claim 21, wherein the gripping portion is hinged with the developing cartridge housing.

24. A developing cartridge usable with an image forming apparatus, the developing cartridge comprising:
a housing having an upper surface and a lower surface to accommodate a developing component; and
a handle disposed on the upper surface of the housing, and including a gripping portion and a support portion to connect the gripping portion to the upper surface of the housing;
wherein the gripping portion forms an acute angle with the upper surface of the housing.

25. An image forming apparatus, comprising:
a lower frame;
an upper frame rotatably connected to the lower frame; and
a developing cartridge disposed in one of the lower frame or the upper frame comprising:
a housing having an upper surface and a lower surface; and
a handle disposed on the upper surface of the housing,
the handle including a gripping portion forming an acute angle with the upper surface of the housing, and a support portion to connect the gripping portion to the upper surface of the housing.

26. The image forming apparatus of claim 25, wherein the developing cartridge is detachably coupled to the lower frame of the image forming apparatus.

27. The image forming apparatus of claim 26, further comprising:
a fuser unit is disposed in the lower frame and in front of the developing cartridge in a direction in which the developing cartridge is detached.

28. A developing cartridge usable with an image forming apparatus, the developing cartridge comprising:
a housing detachable connected to the image forming apparatus and having an upper surface and a lower surface; and
a handle rotatably connected to the housing and having a closed state and an open state so that in a closed state the handle is substantially parallel to the upper surface of the housing and in an open state the handle forms an acute angle with the upper surface of the housing.

29. The developing cartridge of claim 28, wherein the handle is placed in the open state to detach the housing of the developing cartridge from the image forming apparatus.

30. A method of detaching a developing cartridge from an image forming apparatus, the method comprising:
rotating a handle of the developing cartridge to an open state in which an upper surface of the developing cartridge forms an acute angle with the handle; and
moving the developing cartridge from the image forming apparatus.

31. A developing cartridge usable with an image forming apparatus, the developing cartridge comprising:
a housing;
a handle formed on the housing, and having a grip portion and a support portion extended from a surface of the housing at an acute angle with respect to the surface to fixedly support the grip portion.

32. An image forming apparatus comprising:
a frame; and
a developing cartridge disposed in the frame, and having a housing and a handle formed on the housing, and having a grip portion and a support portion extended from a surface of the housing at an acute angle with respect to the surface to support the grip portion with respect to the surface.

33. The image forming apparatus of claim 32, wherein the frame comprises a lower frame to receive the developing cartridge, and an upper frame rotatably connected to the lower frame and having at least one of a scanning unit and an exposing unit.

34. The image forming apparatus of claim 33, wherein the upper frame opens and closes a portion of the lower frame, and the developing cartridge is inserted in the lower frame through the portion of the lower frame.

35. The image forming apparatus of claim 33, wherein the upper frame accommodates a portion of the handle when the upper frame covers the lower frame.
